(19) United States
(12) Patent Application Publication
(10) Pub. No.: US 2005/0033616 A1
(43) Pub. Date: Feb. 10, 2005

(54) Travel management system providing customized travel plan

(75) Inventors: John Vavul, Honolulu, HI (US); Harold Williams, Portland, OR (US); Heidi Vavul, Honolulu, HI (US); Christine Fitch, Waimanalo, HI (US)

Correspondence Address: HELLER EHRMAN WHITE & MCAULIFFE LLP, 1666 K STREET,NW, SUITE 300, WASHINGTON, DC, 20006, US

(73) Assignee: EzRez Software, Inc., Honolulu, HI (US)

(21) Appl. No.: 10/909,337

(22) Filed: Aug. 3, 2004

Related U.S. Application Data
(60) Provisional application No. 60/492,565, filed on Aug. 5, 2003.

(51) Int. Cl. G06F 17/60

(52) U.S. Cl. 705/5

(57) ABSTRACT

A travel manager system and methods are disclosed for conducting parallel searches of travel information sources, screening search results against contract filters and optimizing travel itineraries according to client preferences.

### CORRESPONDING RELATED APPLICATIONS

The present invention claims the benefit of U.S. Provisional Patent Application Ser. No. 60/492,565 by John Vavul et al., filed on Aug. 5, 2003, and entitled “Travel Management System Providing Customized Travel Plan”. The present application claims the benefit of and priority to this provisional application, the entire contents of which are incorporated by reference herein in its entirety.

### BACKGROUND OF THE INVENTION

1. Field of the Invention

The invention relates to the field of travel solutions. In particular, this invention relates to a system and method for managing travel inventory and distribution.

2. Background of the Invention

Information technology has revolutionized the concept of travel management. It has facilitated the emergence of user-friendly travel solutions such as online booking; these services previously required the user to painstakingly arrange his/her travel requirements or employ the services of a travel agent.

Today, users access retail sites like www.expedia.com and www.travelocity.com for reserving air tickets, rail tickets, hotel rooms, vehicles, cruise packages, etc. Such users include individual end users, corporate customers, travel agents and affiliates, sub agents and others. These online booking sites have provided alternatives to traditional methods that involved a lot of manual intervention. The recently developed online systems provide a user with an online platform that caters to his/her various travel requirements. These systems consolidate various travel requirements of a user and provide the user with a consolidated list of possible solutions.

Present day systems allow a user to input a travel related query that is based on certain pre-defined parameters. These systems then search the databases of various associated service providers. Outputs of such systems include lists of search results that match—completely or approximately—the requirements set by the user. For example, a user may wish to find a flight between New York and Miami on certain specific dates. In this case, the system may conduct a search in the databases of various airlines and then output a list of possible flight options containing information regarding duration of each flight, the cost of that flight, and a few other details. As an alternate example, a user may wish to find a hotel room for a certain duration at a certain location. The system will conduct a search in the appropriate databases and output the result in the form of a list of accommodation options, with their ratings, their prices, and other related details.

Certain on-line travel systems allow the user to input more than one requirement at one instance and these systems output a list of possible solutions that satisfy all these requirements. For example, a user may simultaneously input his/her constraints regarding the required flight and accommodation. In such a case, the system will conduct searches in the appropriate databases and output one or more results that simultaneously satisfy these two sets of requirements. The result in such cases is usually obtained as a consolidation of results of searches in various kinds of databases (e.g., airline databases, hotel databases and others). Once the user has this information, he/she can then create a “best possible combination” that suits his/her needs. Of course, one of the outputs could be a combination itself (for example, a package tour), and in such a case, the user may choose to take this option.

Most on-line systems allow the user to optimize the search result with respect to the price/cost of the query. For example, a user may input a query to find a round-trip air-ticket between New York and Miami on certain dates and a hotel for the duration of stay (in Miami). In this case, the system will conduct a search among various databases of hotels and airlines etc. and will then output the result in the form of a list of hotels and a list of possible flight options. If the user has opted for optimizing the travel solution according to cost, then both the lists (i.e. the list of hotels and the list of flight options) will be listed in order of increasing costs.

The above-mentioned systems provide one means of booking travel arrangements. However, such systems are limited in their utility and functionality, such as the limitations noted below.

Although these systems are capable of searching multiple databases simultaneously, their output is limited. For example, if a user inputs the following travel requirements: round-trip flight and accommodation for a trip from Miami to New York Miami on certain dates and a “rental car” for the duration of stay in New York, then the output of such a query would be a list of search results comprising a list of possible flight options, a list of possible accommodation options, and a list of possible rental-car options. Hence, this leaves the user to identify the combination from the plethora of choices (that are provided to him/her by the on-line system) and the user will have to choose manually the “best air-flights” according to his/her needs (taking into account both the cost and the time), the “best accommodation” (taking into account the location and the cost) and the best “rental car option” (taking into account the cost and the amenities, e.g., a mobile phone, provided in the car).

Moreover, such on-line systems are limited in their ability to provide customized solutions for search or distribution of travel products, and they are also limited in catering to various corporate and/or organizational requirements. For example, while a chain of hotels may provide certain benefits to employees of a given organization (e.g., because of prior agreements and contracts between the hotel chain and the organization), present day systems are unable to capture these discounts and relationships. In other words, the level of customization offered by such solutions is limited.

Also, most systems require the user to make the payment by a single mode of payment, such as a credit card, for availing their services. They do not allow a user the flexibility to combine multiple modes of payments (e.g., credit card, check, and wire transfer) for making their payment.

In addition, existing system are limited in their ability to consolidate search results according to specific requirements or ‘rules’ from multiple supply sources (including merchants, legacy central reservation systems, and internal databases) and provide the end-user with a unified set of output.

Other problems with the prior art not described above can also be overcome using the teachings of the present invention, as would be readily apparent to one of ordinary skill in the art after reading this disclosure.

### BRIEF DESCRIPTION OF THE DRAWINGS

FIG. 1 illustrates an environment in which a Travel Manager may operate according to an embodiment of the present invention.

FIG. 2 is a flowchart that illustrates steps involved in installing a Travel Manager according to an embodiment of the present invention.

FIG. 3 illustrates various exemplary modules of a Travel Manager according to an embodiment of the present invention.

FIG. 4 illustrates sub-modules of an Installation Module according to an embodiment of the present invention.

FIG. 5 illustrates sub-modules of a Travel Plan Module according to an embodiment of the present invention.

FIG. 6 is a screenshot of a Graphical user interface that facilitates preferential settings for area, zone and airline for a client during installation according to an embodiment of the present invention.

FIG. 7 is a screenshot of a Graphical user interface that supports contract in the Contract Management Module according to a embodiment of the present invention.

FIG. 8 is a flowchart that illustrates the steps performed by a Travel Manager to perform customized searches according to an embodiment of the present invention.

FIG. 9 is a flowchart that illustrates steps performed by an Aggregator Module according to an embodiment of the present invention.

FIG. 10 is a flowchart that illustrates a parallel searching process performed by a Parallel Searching Module according to an embodiment of the present invention.

FIG. 11 illustrates an exemplary itinerary prepared by a Travel Manager according to an embodiment of the present invention.

FIG. 12 illustrates another exemplary itinerary prepared by a Travel Manager according to an embodiment of the present invention.

FIG. 13 is a screenshot of a Graphical User Interface for performance management according to an embodiment of the present invention.

FIG. 14 is a screenshot of a Graphical user interface that illustrates support for different modes of payment according to an embodiment of the present invention.

FIG. 15 is a screenshot of a Graphical user interface that illustrates contract data maintained by a billing module according to an embodiment of the present invention.

FIG. 16 illustrates various exemplary modules of a booking module according to an embodiment of the present invention.

FIG. 17 illustrates an exemplary data record hierarchy for hotel information according to an embodiment of the present invention.

FIG. 18 a flowchart that illustrates steps performed by a Travel Manager in conducting a parallel search of information sources according to an embodiment of the present invention.

### DETAILED DESCRIPTION OF THE EXEMPLARY EMBODIMENTS

Reference will now be made in detail to exemplary embodiments of the present invention. Wherever possible, the same reference numbers will be used throughout the drawings to refer to the same or like parts.

The disclosed invention relates to a Travel Manager that provides efficient tools for managing various travel requirements. Travel Manager integrates the travel solutions provided by various agencies like airlines, hotels and car rentals into one common platform, then performs parallel processing of information from many different databases and finally integrates the resulting information to provide the end user with a set of one or more complete travel itineraries.

Travel requirements of a user may include air tickets, accommodation, city-tour packages, holiday packages, cruise packages, conference packages, car rentals, bus tours, limousine rentals, helicopter and air-plane rides, boat rides, visits to jungles, theme parks and other exotic places, etc. However, the information relating to these different services is provided by distinct information systems and databases, which are often unrelated to each other. Travel Manager integrates two or more of these services and solutions and provides the user with an integrated output to meet his/her travel needs.

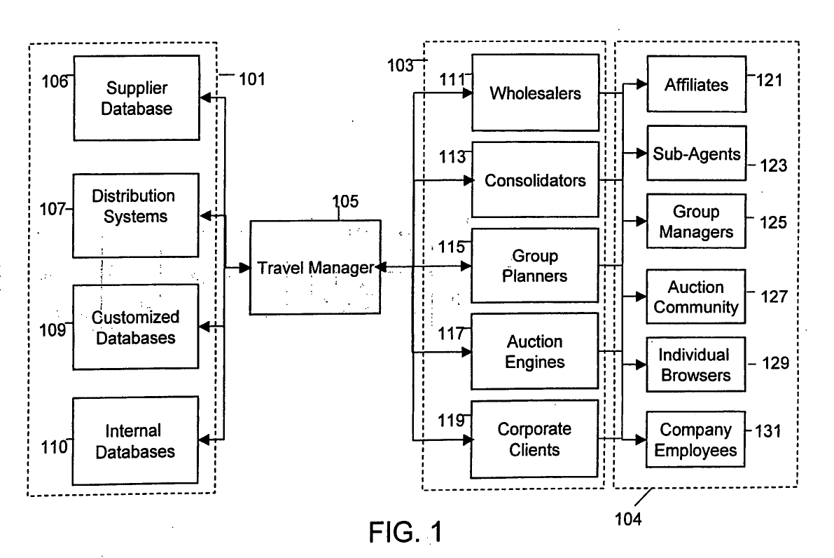

FIG. 1 illustrates an environment in which the present Travel Manager may operate. Travel Manager 105 acts as an intermediary between a first party comprising information suppliers 101 and a second party comprising clients 103 and end users 104. Travel Manager 105 facilitates the management and flow of information between these two parties.

Information suppliers 101 maintain and provide information related to various travel solutions. The information suppliers may host and supply this information by means of electronic databases. Information suppliers in context of the disclosed invention may refer to such databases. Information suppliers 101 comprise Supplier Databases 106, Distribution Systems 107, Customized Databases 109, and Internal Databases 110.

Supplier Databases 106 contain information relating to inventory of various suppliers that provide travel solutions. These suppliers include hoteliers, air fleet providers, ‘chartered airline providers’, car rental providers, and holiday package providers. These suppliers may maintain their individual databases or may provide consolidated databases.

Distribution Systems 107 contain global information relating to various travel solutions. These systems contain comprehensive information relating to all forms of inventory related to travel. For example, these may contain information about different tourist spots, major hotels located in or near these tourist spots, inventory of various hotels and their room availability, different modes of travel available for reaching a tourist spot etc. These Distribution Systems can be accessed by making phone calls to the associated call centers or by accessing them over the Internet. Presently such information is provided by Distribution Systems including Global Distribution System (GDS) and Alternate Distribution System (ADS). Sabre, Worldspan, Galileo and Amadeus are examples of organizations that manage and host GDS. Organizations maintaining ADS include Inntopia and Pegasus.

Customized Databases 109 contain specific information relating to some specific aspects of travel. Indeed, these databases may contain information provided by a single supplier or may contain consolidated information from multiple suppliers providing similar services. For example, a customized database may contain information related to all the car rental companies located in a particular location.

Internal Databases 110 are databases that are particular to a client. These databases are not publicly available and are usually maintained by the client for a particular end user. These may contain information related to the customers of the client (customer profiles) or may contain information that is specific to a geographic location (like rental car operators operating in a particular city). The access to these databases is restricted to limited users.

Clients 103 are businesses as well as corporations and organizations that either provide or need various kinds of travel solutions. Such providers could even be facilitators who act as intermediaries between the service providers like airlines, hoteliers, and the end users, and such facilitators may provide their services via a web interface, in person, and/or via phone. In context of the disclosed invention, Clients refer to those facilitators which use Internet/intranet for providing such services. These clients may include Travel Agents 111, Consolidators (and Wholesalers) 113, Group Planners 115, Auction Engines 117 and Corporate Clients 119.

Consolidators 113 are businesses that buy travel services (e.g. flight tickets, hotel rooms) in substantially large quantities and in advance based upon the demand forecast, and later sell it to the end users 104, thereby making a profit. Group planners 115 refer to organizations like “Thomas Cook Holidays” and “Liberty Travel” that provide holiday packages, customized group packages, conference packages, and other such services. Auction Engines 117 refer to websites like www.ebay.com that auction various products related to travel (such as air-tickets) to end users 104. Clients may also include websites like www.hawaiianvacations.com that interact with end users 104 via a graphical user interface and provide real time travel solutions.

End users 104 may be Affiliates 121, Sub-agents 123, Group managers 125, Auction community 127, Individual browsers 129, or company employees 131. These end users access the websites hosted by clients 104 for personal or commercial travel planning.

Travel Manager 105 acts as an Application Service Provider (ASP) that manages and distributes information between information suppliers 101, clients 103 and end users 104. By means of the ASP based architecture of Travel Manager 105, clients 103 are able to access the information they require from information suppliers 101. The functions performed by Travel Manger 105 are not limited to retrieval, consolidation and display of information. Travel Manager 105 is an intelligent system that enables rule based parallel processing of the information retrieved from information suppliers 104. This results in providing concise and relevant travel solutions to clients 103 and end users 104 compared to a plethora of solutions obtained by mere consolidation of information from the information suppliers.

Travel Manager 105 also provides clients 103 with a customized web-interface. The clients and their affiliates can use the functionalities/services of Travel Manager via this web-interface, which may be a customized Graphical User Interface (GUI) provided at their website. And, if required, the clients can customize the GUI (of their website) with respect to their needs (either during the installation of Travel Manager 105 or later, if required). This ensures that all the travel requirements of the clients and/or their affiliates are met by using a single interface, without necessitating the user to search other information sources (such as travel websites, brochures, etc.).

The Travel Manager is highly configurable and a system administrator can configure it appropriately for each private-label version of the Travel Manager. For example, the administrator can select different rules for different audiences, thereby, customizing it appropriately. For example, The Travel Manager could be configured to allow certain contracts/inventory to be sold independently, or require that they be sold with other items. Additional examples include: pricing displays, hold periods, modification allowances, etc. The rule engine in the Travel Manager can allow for any type of rules configuration (that is related to specific travel information) for a “smart search” of the connected supply sources and databases.

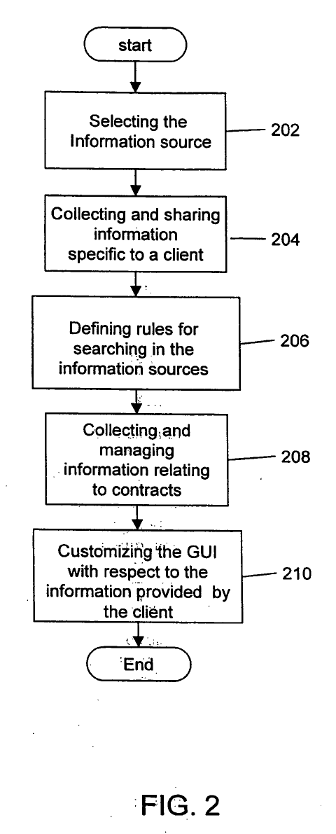

Travel Module 105 is customized according to the requirements of a client at the time of installation. The steps involved in installation of Travel Manager 105 for a particular client has been further elaborated with the help of FIG. 2. In step 202, based on the requirements for information of a client, Travel Manager 105 selects the information sources. The list of information sources can be provided by the client or these may be decided by the Travel Manager based on the parameters defined by the client. These parameters may be related to selecting a travel information supplier operating in a geographic region or may be related to a specific travel service (like GDS). These may also be related to selecting information suppliers that have tie-ups with the particular client. In step 204, Travel Manager 105 collects the information that is specific to the client. This information may relate to the clients' organization structure, its policies, its affiliate organizations, the agents working in the organization etc. Travel Manager 105 may further share the common information between the client and organizations/personnel related to the client. This relationship may exist between a client and its affiliates, a client and its co-brands, a client and its agents etc. The information gathered from the client in step 204 is used for defining the rules in step 206. These rules act as guidelines that govern the travel solution for an end user. At step 208, Travel Manager 105 collects and manages the information relating to the complex contracts between the client and its various supplier. These complex contracts may relate to terms and conditions laid down by a client, like availability of rooms, specific benefits for a customer etc. Travel Module 105 facilitates the customization of the GUI for a client in step 210. On the basis of the information collected from a client, Travel Module 205 customizes the GUI. In step 210 the GUI of a client may be customized with respect to the end user the client has or with respect to an agreement a client, a suppliers and an end user may share.

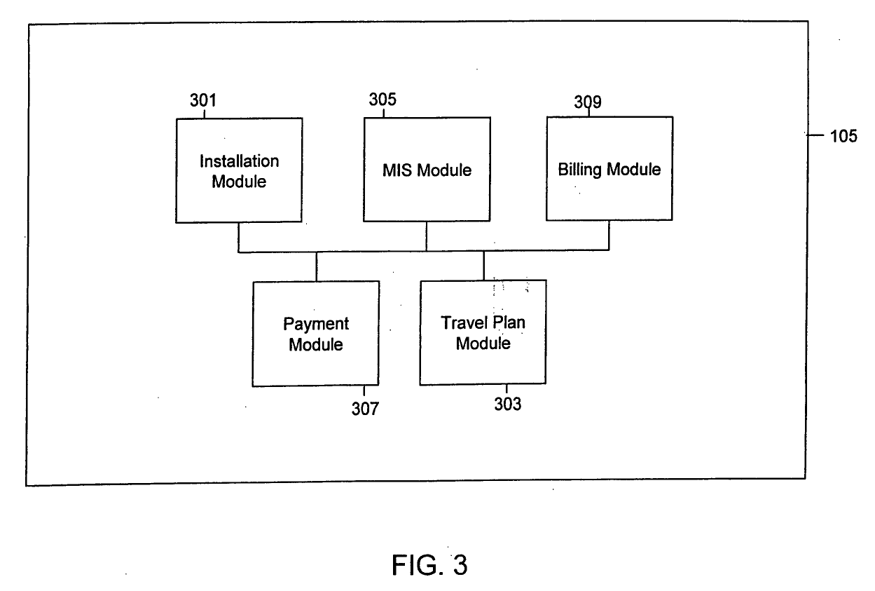

Travel Manager 105 comprises multiple modules that interact with one another to provide various outputs and results. These modules have been illustrated in FIG. 3.

Travel Manager 105 comprises an Installation Module 301, a Travel Plan Module 303, a MIS Module 305, a Payment Module 307 and a Billing Module 309.

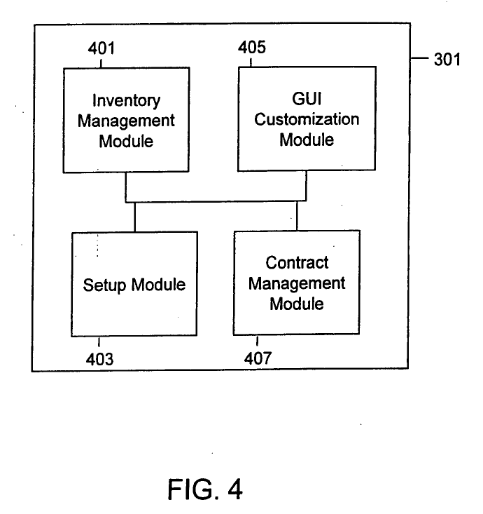

Installation Module 301 is a part of Travel Manager 105 and it has been described further in conjunction with FIG. 4. referring to FIG. 4, the sub-modules of Installation Module 301 comprise an Inventory Management Module 401, a Setup Module 403, a GUI Customization Module 405, and a Contract Management Module 407.

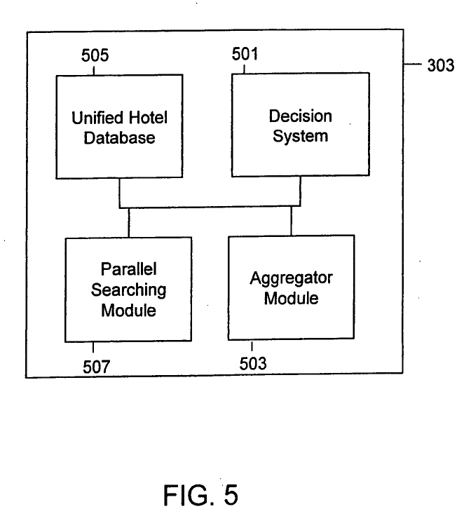

Travel Plan Module 303 has been described further in conjunction with FIG. 5. Referring to FIG. 5, Travel Plan Module 303 comprises a Decision System 501, Aggregator Module 503, a Unified Hotel Database 505 and a Parallel Searching Module 507.

Inventory Management Module 401

Inventory Management Module is responsible for managing the information related to the information suppliers associated with each client.

During installation of Travel Manager 105 over the client system, the client has an option to select various information providers and databases from which data and information will be retrieved. Indeed, it is up to the client to choose one or more GDS and one or more ADS systems. The choice of the information suppliers used by the client may be governed by the contracts between the client and the Information Supplier (and in some cases, the clients may select Suppliers based on need for inventory, with no pre-established contract). For example, if client ABC has a contract that gives it the permission to access the inventory database of XYZ Hotels, then the present system customizes the Travel Manager 105 to include the database of XYZ Hotels in the list of information suppliers for ABC client. After the client has selected the preferred information sources, the present system establishes a link with these information sources. Note that the Travel Manager and the corresponding application is completely agnostic to the “supply sources and databases”, but the sources used as well as the rules and conditions set forth (within the Travel Manager) will determine the types of results and information that are eventually given to the user when he/she queries the Travel Manager.

Travel Manager 105 may also provide additional facilities and information regarding different activities as a part of travel inventory. For example, while listing a trip to Paris the client may also list a trip to Disneyland as a possible activity (that is associated to it). The trip to Disneyland may also include necessary provisions of the bus or train services (as a part of the travel inventory). Travel Manager 105 has provision for listing this activity as a standalone trip, or automatically building it into a trip, or offering it as a complementary add-on after a trip has been built.

Setup Module 403

This module considers user preferences while installation, wherein these preferences are specific to a client and its end-customer needs.

Travel Manager 105 provides the client with an option to set rules based on business relationships with others (e.g., co-brand companies and organizations, affiliates, subagents, and corporate clients). For example, if PQR Tours has ABC as its corporate client, then this feature can be listed in the Setup Module and special links may be provided to ABC's end-customers on the website hosted by PQR Tours. In addition, a customized GUI may also be PQR to ABC and its end-customers.

Setup Module 403 also makes the access (to the system information) secure by providing different access rights to different users. For example, PQR Tours may have an accounts department, sales and marketing department, and a unit dedicated to maintaining Travel Manager 105. In such a case, while installing Travel Manager 105, the system administrator can provide different rights to different departments. Conversely, different rights may be provided to different end-customers of ABC. For example, a General Manager of ABC may be provided access to all travel expenses and itineraries of people within his/her department.

Setup Module 403 also provides the facility of default markup values. These default values are values that will be used in cases when the client does not provide any customized values. For instance, if a client charges a predefined sum from sub-agents for a particular activity, then this value will be provided to the system as a default value. However, if a customized value is provided, then it will overrule this default value, and the customized value will be used for all future transactions between the client and its agents.

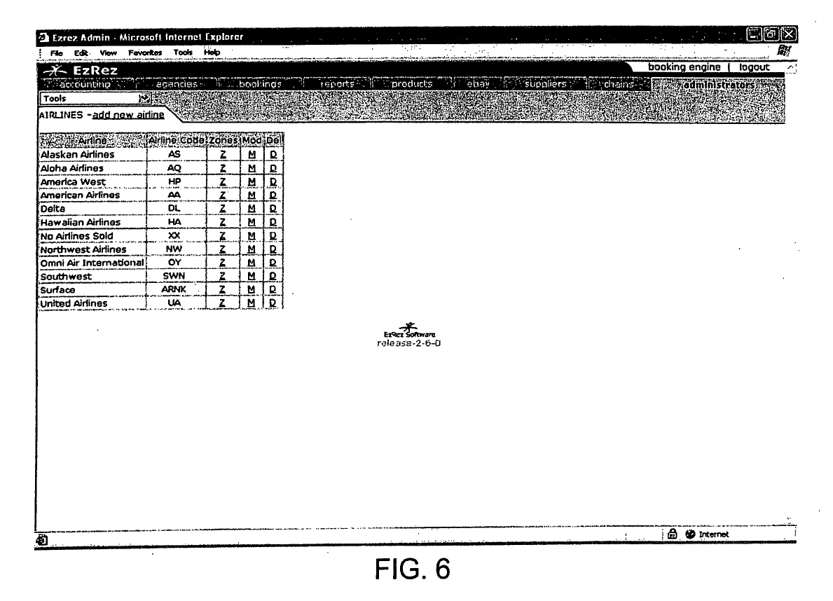

Setup Module 403 allows a client to define specific conditions that later form the “basis for rules” used for conducting various kinds of searches etc. These conditions could be quite diverse and may include choice of service providers (like airlines and hoteliers), suggested airports to fly out of, etc. FIG. 6 is a snapshot of a GUI that shows one such preferential setting. As an example, suppose a corporate client, ABC, enters into an agreement with XYZ chain of hotels, wherein all its employees will get a 10 percent discount. Furthermore, this agreement may allow upgrading of the rooms of ABCs' executives without charge, giving free meals to General Managers or providing free transportation. In such a case, Setup Module 403 would be configured appropriately and this information would be displayed through the GUI of the Travel Manager. (Note that the actual contract/agreement would be stored in Contract Management Module 407.)

Travel Manager 105 further facilitates the sharing of common information among clients who are related to each other (e.g., if one company is the subsidiary of the other). In such cases the disclosed system extracts common features of the “primary” client and distributes it among other clients that are linked to it. This prevents repetitive feeding of information.

As an additional feature, Travel Manager 105 provides a client the choice to set a convenient mode of communication with the suppliers. The present system may also set the contact information of people to be contacted on both the client side and the supplier side. For example, in case the supplier is a hotel that books rooms on the basis of information provided by a given airline, both parties have to be in frequent contact with each other so as to respond to changes (in the travel plan schedule).

GUI Customization Module 405

Travel Manager 105 also customizes the Graphical User Interface (GUI) of a client on the basis of its preference and requirements. These requirements can be based upon the relationships among the end users, information suppliers and the client. If an end user has a particular relationship with a supplier, then the disclosed system is capable of customizing the GUI based on this relationship. This specialty of Travel Manager 105 can also be of use if a client provides services to multiple corporate clients. For example, if a company DEF has corporate tie-ups with ABC, PQR etc. then within Travel Manager 105, the user interface of DEF Company can be customized individually with respect to each of these corporate clients.

Travel Manager 105 manages and customizes the GUI of a client, based on the end users it has. In other words, the GUI of a client that provides travel plans to company employees would be different from that of a client handling individual users seeking a holiday plan. Typically, all this customization is done in Setup Module 203.

Furthermore, Travel Manager 105 provides the ability to create, schedule, manage, seat and yield charter flights and inventory and the ability to make reservations for this inventory in other systems that may not contain the inventory or have the ability to do so. Furthermore, the Travel Manager can combine other sources of inventory to its own charter flights using dynamic routing. Dynamic routing is the ability to combine air legs from different sources of inventory into one trip.

Travel Manager 105 also manages the content of the GUI with respect to the needs of a client and its end-customers. Travel Manager 105 customizes the display of images, banners, and the links on the website hosted by the client, etc. The customization is done on the basis of the requirements of the client and its affiliates. The customization of the items mentioned above can also be done on the basis of the priority set by the client for different advertisers.

Contract Management Module 407

Travel Manager 105 also makes provisions for capturing and implementing complex contracts between suppliers and clients. These contracts may relate to the terms and conditions defined by a supplier, like the availability of inventory, cost of services, special benefits for a user, etc. Travel Manager 105 maintains a record of such contracts, and uses the conditions mentioned by them to decide their availability and priority in the itinerary displayed to an end user.

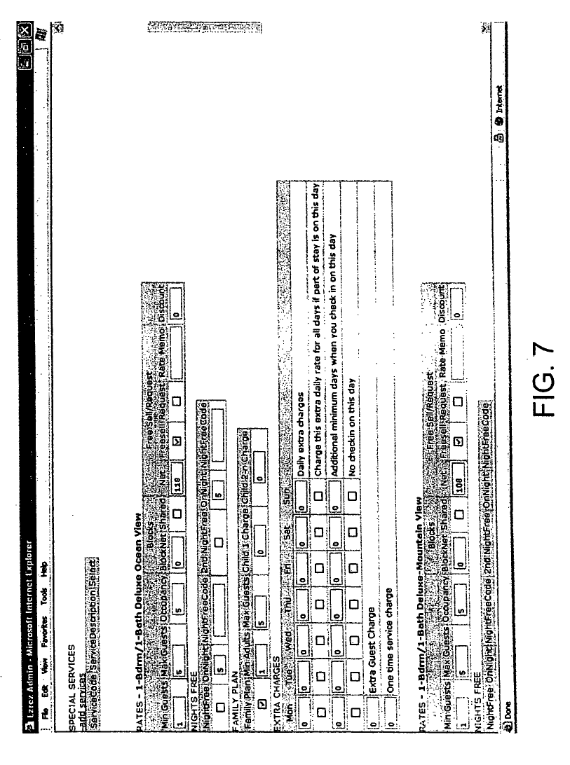

FIG. 7 displays a snapshot of such a contract. The contract displays various types of rooms available in a hotel, and the additional features available in rooms, such as ocean view, availability of a “liquor bar” in the room, etc. The maintenance of such contracts enables customized search to take place (once the end-customer provides his/her query).

Travel Plan Module 303

Travel Plan Module 303 disclosed herein describes the method by which the Travel Manager 105 generates a customized travel plan based on the requirements of an end user.

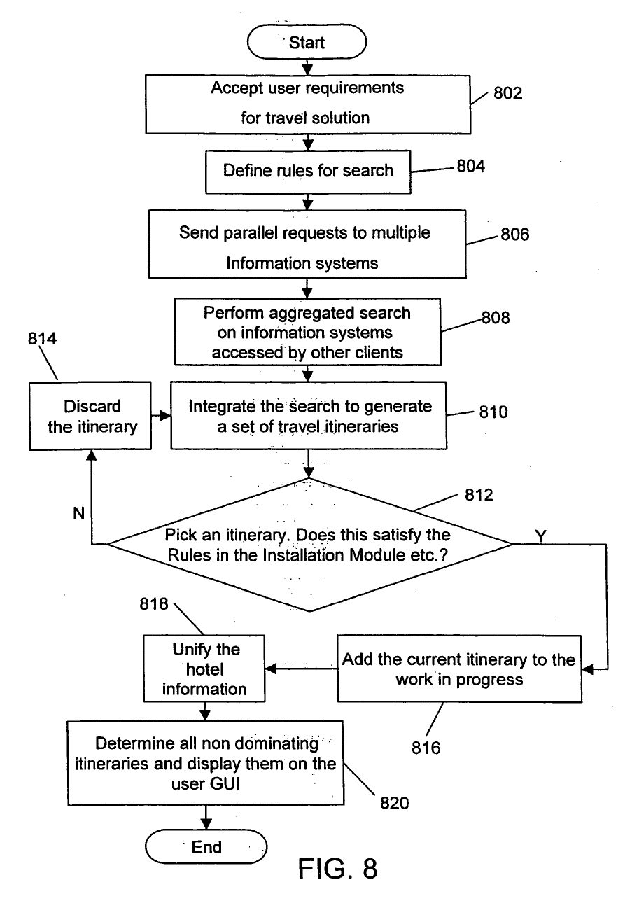

FIG. 8 is a flowchart that illustrates the steps performed by the Travel Manager 105 to perform customized searches. The method begins at step 802 with the GUI of Travel Manager 105 accepting the requirements of a travel-related request from an end user. These requirements may include preferences of the end user for a destination, a mode of travel, activities linked to a trip, etc. At step 804, these preferences are used to define some of the rules for Decision System 501; other rules may be obtained from Inventory Management Module 401, Contract Management Module 407, and Setup Module 403. Decision System 501 uses all these rules to perform the search. At step 806, Travel Manager 105 begins the search by sending parallel requests to multiple information suppliers. These information suppliers may be databases that provide services related to different aspects of travel or may be Distribution Systems like GDS and ADS. -By performing parallel searches, the Travel Manager is able to significantly reduce the time taken to build a set of valid travel itineraries. Results of the parallel search requests are received, and at step 808, Decision System 501 performs an aggregated search. This aggregated search is performed over multiple information suppliers. These information suppliers may be associated with the client handling the request for a travel solution or may be the information suppliers linked to other clients providing an identical travel solution. At step 810, Decision System 501, combines the results of various searches to generate a valid travel itinerary; this can be achieved by doing exhaustive combinations and permutations, or by using well-known algorithms like Traveling Salesman, A* Technique, Branch and Bound, etc. or by using any other method known in the art.

At step 812, Decision System 501 checks if the travel itinerary generated at step 810 meets the rules set by the user (or the client). If a particular generated itinerary does not meet the rules then it is discarded in step 814 and the method goes back to step 810. In case the itinerary satisfies the rules, this itinerary is selected as a valid itinerary and added to the “work in progress resource” at step 816. The Travel Manager at step 818 unifies the hotel related information available from various information sources. Once all valid itineraries have been built and either added to the “work in progress resource” or discarded, the present method computes the non-dominating itineraries and displays them over the user GUI at step 820. An itinerary is called non-dominating if it is “better” with respect to at least one of the parameters (that has defined by the end user or the client) when compared to all other non-dominating itineraries. For example, if a travel itinerary, A, provides less travel time but higher price than another travel itinerary, B, then both A and B are non-dominating itineraries. However, if another travel itinerary, C, provides more travel time and has a higher cost than A, then C is dominated by A and can be removed (from the set of non-dominating itineraries).

Decision System 501

Travel Manager 105, and, in particular Decision System 501, is also capable of performing various kinds of optimization searches and with respect to various other dimensions. Indeed, such dimensions may include the cost of the travel itinerary, time of travel, “ease of travel’ and several others (that are defined by the client). Note that the ‘Ease of travel’ may consider “comfort while traveling” as its basis. For example, an airline that provides sleeping facility in its Business Class may rate higher on with respect to the “ease of travel” than one that does not. These optimizations are also governed by the rules that are provided in various modules of Installation Module 301. The end result of such optimizing could also be a set of non-dominated travel packages.

Aggregator Module 503

Travel Manager 105 is also equipped with an Aggregator Module 503 that provides a user with an aggregated solution. This module expands the scope of search to include the information pool of other clients that may be providing similar travel solutions; such clients may be wholesalers, consolidators, charter-airlines, and travel agents that may share their information (including contracts) with the application provider. Hence, this module provides the end user with more options to select the desired travel solution. An Aggregator function also ensures that all the travel solutions are made available to the customer via one interface. Hence, the Aggregator Module obviates the need for the end-customer to go to another web interface. For example, if an end customer, A, searches for a travel itinerary with the system provided by client, B, then the search result will also display travel options provided by clients, C and/or D. Aggregator Module ensures that if the end user, A, selects the travel solution provided by client C, the end user is not diverted to the web interface of client C.

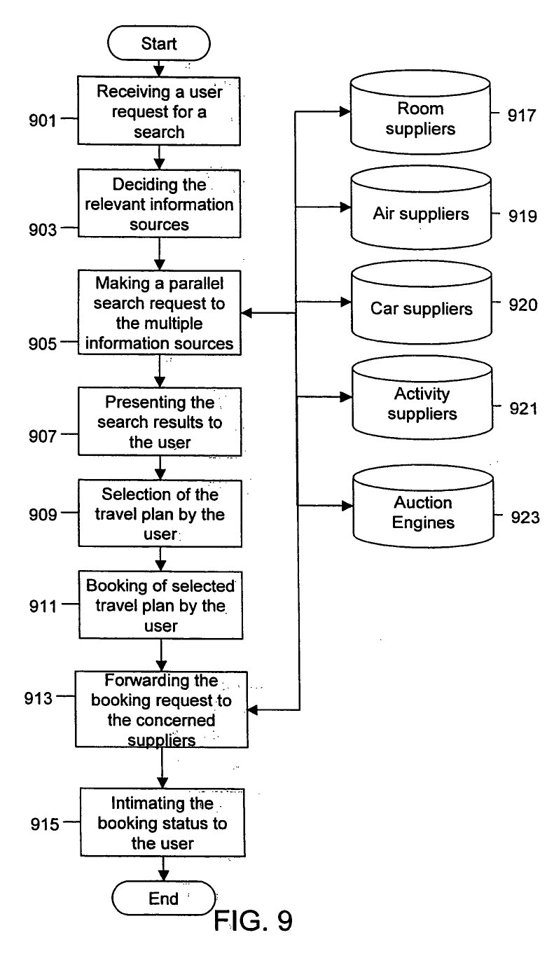

The Aggregator Module has been explained further in conjunction with FIG. 9. Referring to FIG. 9, at step 901, the Travel Manager receives a search request from a user. At step 903, the Travel Manager decides the information sources from which the travel solution related information has to be obtained. At step 905, the Travel Manager makes parallel search requests to these information sources using the Parallel Searching Module #?. The relevant travel solutions as unified are presented to the user at step 907. For unifying the multiple search results the Travel manager may use functionalities like the Unified Hotel Database. At step 909, the user selects the travel plan from amongst the choices presented at step 907. At step 911, the user books the selected travel plan. The selected travel plan may contain travel solutions from multiple suppliers. These suppliers may be related to the client whom the user has requested for the travel solution. These may also be suppliers related to other clients of the Travel Manager. At step 913, the Travel Manager forwards the request for booking the selected travel plan to the suppliers involved in generating that travel plan. These suppliers may include room suppliers 917, air suppliers 919, car suppliers 920, activity suppliers 921 and auction engines 923. Once the Travel Manager receives the confirmation from the concerned suppliers, the user is informed of the booking at step 915. The user may also be provided a Passenger Name Record (PNR) defined? at this step. Using this PNR the user may check the status of the bookings at later stages.

Unified Hotel Database 505

Often there is a discrepancy in the information available from different information sources. For example, different information sources may contain different descriptions for the same hotel. Travel Manager 105 offers the client an option of obtaining unified and standardized information related to various hotels. This information is stored in a Unified Hotel Database 505. Unified Hotel Database 505 gathers information from various sources and standardizes this information to remove discrepancies. Unified Hotel Database 505 ensures that multiple entries related to a single hotel are unified, standardized and displayed to the end user as a single entry, thereby, eliminating different entries (for the same hotel) to the end user. Additional information contained in the Unified Hotel Database may be appended to the information obtained from searching the information sources leading to the standardization of the search results for the user.

The disclosed method may use information available in Internal Databases 110 to perform custom searches. Internal Databases 110 contain knowledge that may be specific to an end user or may be specific to a parameter like geographically local knowledge (e.g., a description of small hotels present in a city). These Internal Databases 110 may be maintained by the client or the Application Service Provider (ASP). Such databases make searches more efficient and effective (with respect to time and cost) by providing additional rules for narrowing various search results. For instance, when the General Manager of company ABC requests a travel solution, the rules for the search may be defined by information related to his corporate position, his likes and dislikes for hotels, cars, flights, and additional benefits he might be eligible for due to a tie-up with a hotel, etc. All these parameters would usually be provided in a client's internal database.

Internal Databases 110 can be conveniently employed by Auction Engines 117 for providing an automated auction system. Travel Manager 105, when associated with such auction engines would then perform searches in one or more Internal Databases 110, which, in turn, would contain personal profiles of a specific set of end users, such as employees of an organization. This facilitates a travel auction with a single click for such users.

The automated auction system facilitates the submission of information (travel solutions for auction) with a single click. This feature is enabled by maintaining a personalized profile of a customer. For example, a user can search for items and, during the booking process, automatically submit a bid to auction sites like eBay and then redirect the user to eBay to pay for the transaction. All the important fields of information about the user, such as full name, shipping address, etc. are automatically extracted from the internal database, thereby, providing an essentially single click online travel auction. This auction submission tool provides a buyer the ability to search for real-time inventory from multiple sources and then, with a single click, automatically submit his/her custom-built itinerary to the auction engine while, at the same time, automatically reserving the inventory in his/her custom-built vacation at each supplier source. This tool also includes automatic reservation cancellation in the various supply sources if payment is not received within an allocated period of time. The tool provides for delivery of all payment and buyer information to the client's inventory management system.

As a custom support, Travel Manager 105 may also perform theme-based searches. While installing the disclosed system, the client can list various themes it would like to offer to the end users. This function is particularly useful for clients who deal with specific types of travel packages, e.g., romance packages for newly married couples, sports packages, cruises, packages to exotic locations, etc. The disclosed method also provides the end users with an option to choose and/or create a theme of their preference. Once the basic rules governing such themes are input in Installation Module 301, the eventual rules governing this search may be obtained from the module. Specific items, such as hotels that specialize with respect to the theme selected, may then be output by the Travel Manager 105.

Travel Manager 105 also provides the end user with an option of selecting an activity as a part of the trip, integrating this activity, and then optimizing the trip. For instance, on selecting a trip to Paris, the user may see on his/her GUI, a trip to Disneyland. By selecting this trip to Disneyland and optimizing it with respect to time and/or cost, the end user may receive a comprehensive itinerary that displays the total time that his/her trip will take and the associated cost.

As a user support, the disclosed method also provides the end user with add-ons for travel packages and itineraries that can improve the trip. Such add-ons may be additional facilities provided by the supplier chosen by the end user. For example, the user may be provided a room with a view, a hotel with free gymnasium facilities, etc.

Promotional packages can also be communicated to the end user by means of the Travel Manager 105. By activating this option the end user indicates preference to these offers (e.g. discounts, gifts, coupons, etc.) over other search results.

Parallel Searching Module 507

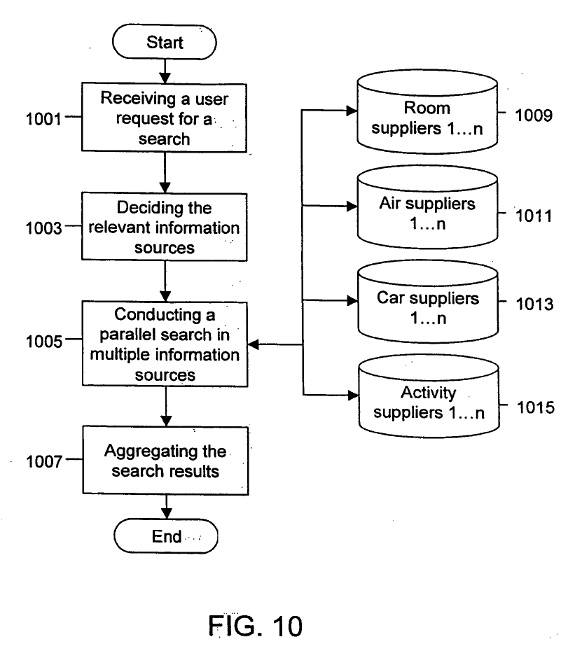

The system allows clients to search in parallel multiple sources of inventory based on system configurations and combine the results into one result set. Further, during the booking and modification processes, the system can handle multiple requests in parallel, thereby speeding up the overall process. Parallel searching has been further illustrated with the help of FIG. 10. Referring to FIG. 10, at step 1001, user inputs a request for a travel solution. At step 1003, the travel manager decides the information sources from which relevant information can be obtained. These information sources may be room suppliers 1009, air supplier 1011, car suppliers 1013 and activity suppliers 1015, etc. At step 1005, the Travel Manager conducts a parallel search in the identified relevant information sources by transmitting formatted queries to each source without waiting to receive results from each. The search results are received and aggregated at step 1007, after which rule based processing is applied on the results.

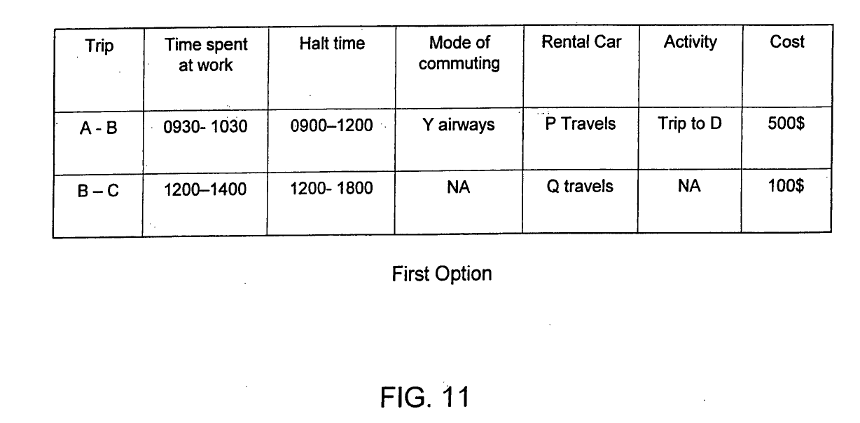

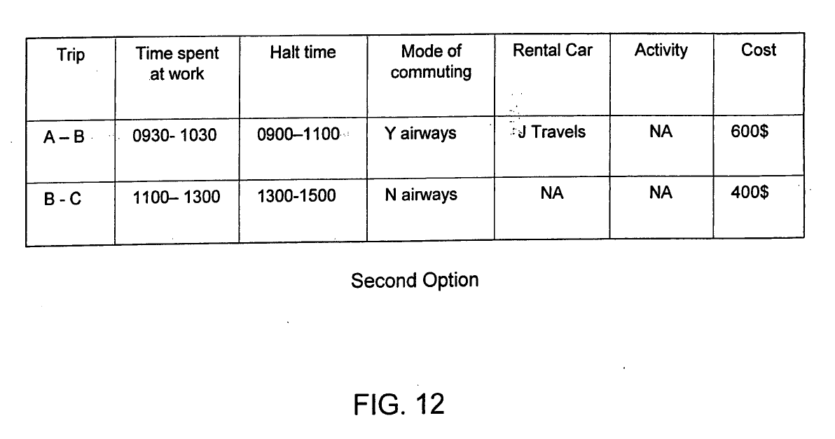

FIGS. 11 and 12 illustrate two examples of search results for a particular trip that may be requested by an end user using the disclosed system. The disclosed system generates trip from A to B and B to C by means of parallel searching in multiple databases and then by integrating this data to present two itineraries—one shown in FIG. 11 and the other shown in FIG. 12. The trip shown in FIG. 11 is an integrated travel plan from A to C, which uses an airline and a rented car for the trip. Since the first trip has more halt time in comparison to the trip in FIG. 12, it may provide the end user with an additional activity, such as a trip to location D. The second trip, on the other hand, provides the option of traveling by air on both legs. The invention displays the above results via the user interface non-dominantly with respect to each other result until the user sets a preference for optimization, or selects one of the options. It can be seen that if the user sets a preference for cost, the search result shown in FIG. 11 will dominate. However, if time is the optimization parameter, then the option shown in FIG. 12 which requires less travel time will receive the preference. On the other hand, if the user sets a preference for the nature of the trip (i.e., theme) to be a holiday trip, the option shown in FIG. 11 might gain priority over the option shown in FIG. 12, as that option provides the user with an alternative activity.

Management of Information System (MIS) Module 205

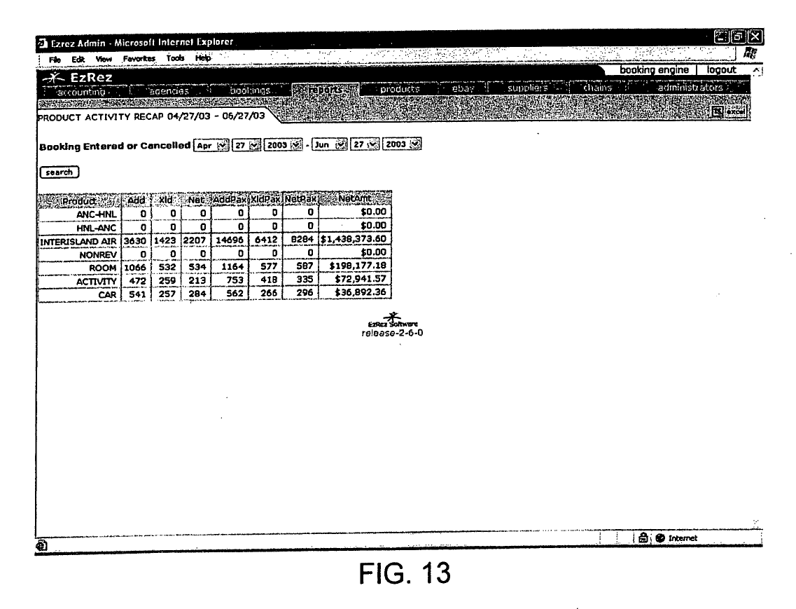

The present method provides an integrated platform for the management of information that is related to travel within a company or an organization. This includes providing various kinds of management information management tools to clients and suppliers. MIS Module 205 includes the performance management tools. FIG. 13 provides a snapshot of a performance manager implemented by the present invention.

MIS Module 305 provides both clients and suppliers with options for preparing various kinds of periodic reports, particularly with respect to travel. For example, travel service suppliers may wish to keep an account of the total number of customers visiting a particular chain of hotels or those that have used a given airline. This may give a supplier bargaining power with a particular hotel chain or airline. To produce such reports and to conduct such operations, the system may require access to historical data, such as the disclosed system tracks historical and current itineraries as well as other required data. In general, the MIS Module 305 enables the generation and delivery of many online reports for various internal as well as external activities. Such reports can vary from simple accounting reports to significantly more complex performance reports.

MIS Module 305 is also equipped with data mining tools. These tools may be used, for example, in predicting future sales and defining marketing policies of various suppliers. In addition, these data mining tools may also provide clients and suppliers with information relating to various habits of a company's employees, the kinds of tourists visiting a particular location, various traveling preferences of the tourists, age groups of tourists that frequent bars etc. in a given city or location, etc. This information helps the clients and suppliers establish correlations among various parameters, and forecast demand to better manage their businesses. Such correlations can later be used for revising the focus of suppliers' sales and marketing policies, or in negotiating better contracts with other parties. For example, if a vacation package supplier determines that customers visiting Cancun visit a particular bar quite regularly, then the supplier may decide to form a mutually beneficial relationship with the owners of that bar.

Customer Relationship Management (CRM) is another tool included in this MIS Module 305. The CRM tool provides means for storing contacts and information of end customers for clients and suppliers and of other parties, organizations, etc. if required. The end customer details may comprise a customer's email address, permanent address, telephone numbers, fax, etc. Among other uses, MIS Module 305 may support direct marketing efforts such as providing updates, coupons, notices of special packages, etc. to customers, or a particular subset of customers. For example, this tool could be used for addressing newsletters by an airline or a hotel chain to its customers.

Travel Manager 105 also makes live tracking of booking activities possible. Using Travel Manager 105, clients and suppliers can get live information relating to the present status of an itinerary and associated end users. MIS Module 305 includes a supplier Travel Manager to automate regular events. Such events may include, for example, updating a room list or releasing blocks of rooms.

As described in Installation Module 301, Travel Manager 105 provides different levels of user access within the organization using the disclosed system. This multilevel access capability manages user access to information in an organization. For example, the marketing department of an organization using the disclosed system may not have access to documents related to finance. This enables better security of information.

Travel Manager 105 facilitates transparency in the system by giving certain access rights to suppliers and clients. By means of such rights, a supplier can access and update its information stored on the client database. This access may be facilitated by means of a client Extranet. The disclosed system also provides a client with information relating to fields that have been changed in the supplier record. The disclosed system may display such tracking of changes in the database by means of highlighting the modified field, or by any other means known in the art.

Payment Module 307

Payment Module 307 provides an end user with the facility to use multiple modes of payments. This provides an end user with flexibility to combine multiple modes of payment for different services. For example, Payment Module 307 may allow a user to pay with cash, check, certificates, credit cards, and other means, which can be sent to the appropriate source for processing, all in parallel.

While supporting payments by check, the present system may ask a user for the check number and the personal identification number linked to the user. After the payment has been accepted, the user receives a printed invoice to help the end user keep a record of the transaction.

In order to maintain transparency regarding the mode of payment, the disclosed system provides end users with the status of payments made. This function updates end users of any change in status. This can be provided in form of a PNR status. The disclosed system allows PNRs from other systems to be combined into one super PNR that the user can reference for their own convenience.

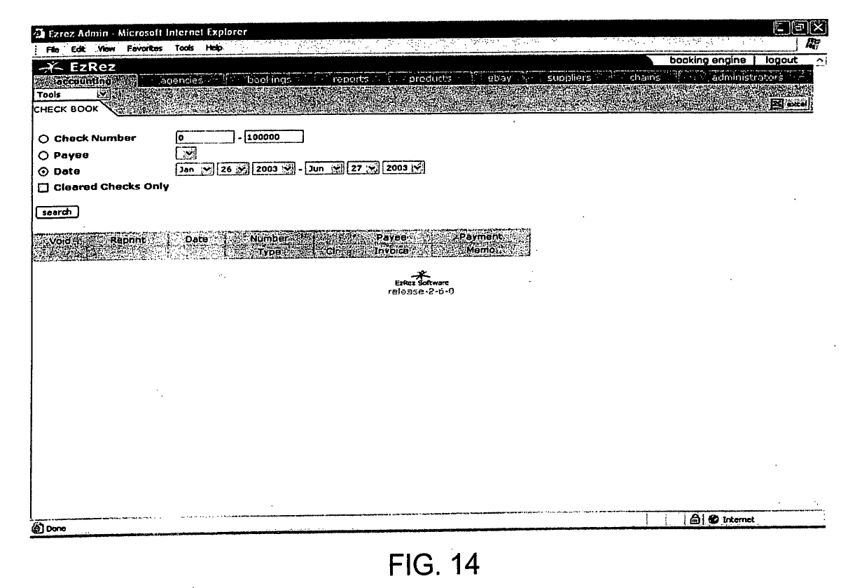

FIG. 14 is a snapshot of one of the user interfaces that enables payment.

Billing Module 309

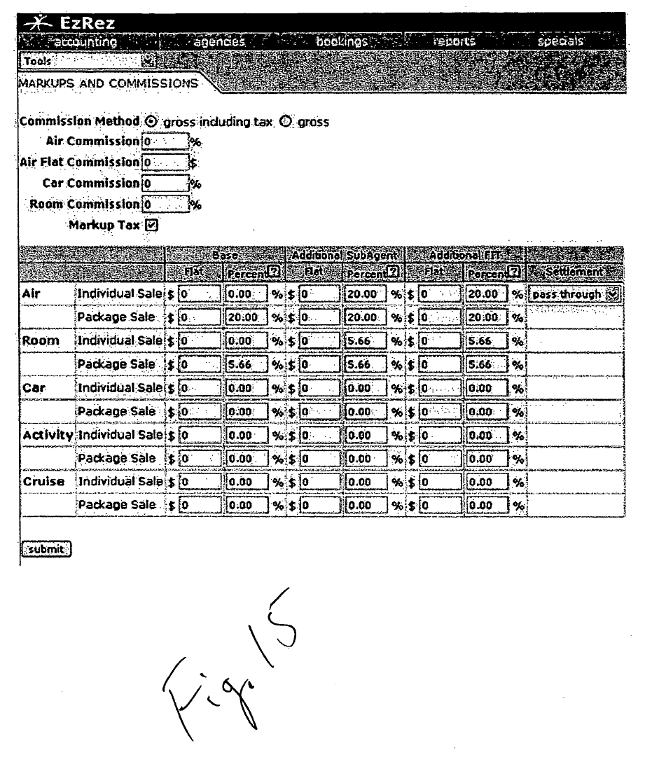

Travel Manager 105 manages the transactions between the various parties involved through a Billing Module 309. Billing Module 309 defines, processes and maintains the information regarding various financial transactions between the involved parties. For example, when a user purchases a travel package comprising a hotel accommodation, a flight ticket and a car rental, the Payment Module 309 will receive a single payment from the user. The Billing Module 309 will then provide the respective hotel accommodation provider, flight ticket provider and car rental provider with their share of the transaction. Billing Module 309 will decide the share for each of these parties, based on the service level agreements between the client and the service providers. Billing Module 309 will also provide transparency in cash flow by facilitating the tracking of payments made by each party involved in the transaction. The disclosed system may also help in generating contracts that define the billing rates of clients, suppliers and end users. Contracts maintained and implemented by the Billing Module 309 may relate to service agreement licensing, monthly maintenance and hosting, transaction fee and custom development. FIG. 15 shows a screen snapshot of a user interface of the present system displaying elements of various contracts maintained by the Billing Module 309. As illustrated in FIG. 15, data elements regarding such contracts stored in a database accessed by Billing Module 309 may include, for example, mark ups and commission rates by type of sale (e.g., individual or group) and the party selling or making the travel arrangement.

Billing Module 309 forms an important part of the business method based on the method and system of the disclosed invention. The business method essentially involves the Application Service Provider (ASP) acting as a mediator between the information service provider and the clients. The information service provider and the client both benefit when an end user makes an online purchase of a travel plan. The business method involves sharing the benefit of such a transaction. Moreover, the clients and the information service providers may be charged for maintaining and hosting services on a monthly basis. The Billing Module will calculate the invoices for the clients and the information suppliers. It may also generate invoices on behalf of the clients or information suppliers for their associated companies partners and customers.

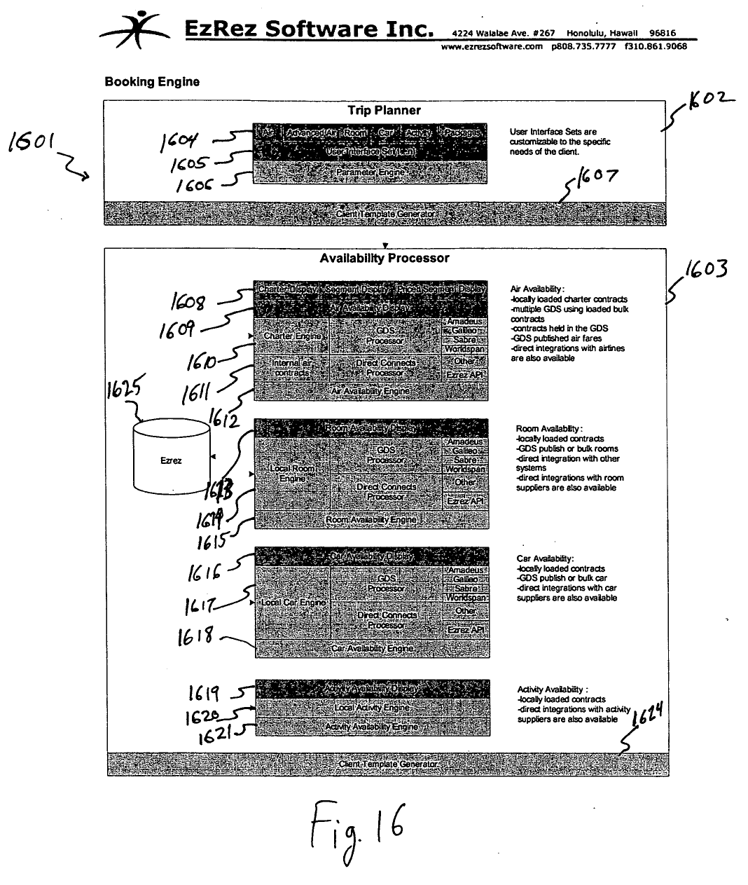

Travel Manager 105 may include a Booking Engine 1601 that provides customizable user interface displays for planning, booking and displaying various elements of a prospective or selected itinerary. Referring to FIG. 16, the Booking Engine 1601 may comprise a client template generator 1607 that produces standardized interfaces for particular clients. Interfacing with client template generator 1607 is one or more parameter engines 1606 which process various parameters related to travel reservation information in order to generate one or more user interface displays 1605 comprising displays for the various travel services or components 1604. The user interface sets 1605 are customizable to meet specific needs of individual clients.

FIG. 16 also shows the Availability Processor 1603 that is part of the Travel Manager 105. The Availability Processor 1603 includes the interface modules for accessing and processing information provided by various travel service suppliers. The Availability Processor 1603 also provides processing of the various types of travel services information to exchange data (e.g., user preferences and service availability) with the Trip Planner 1602 via the client template generator 1624. The Availability Processor 1603 also stores data on travel service availabilities to a database 1625 to facilitate travel planning and analysis of alternative travel options. Within the Availability Processor 1603 may be an air travel availability module comprising display modules 1608 for various types of air travel information (e.g., charter, segment descriptions and price), an overall air availability display 1609, modules 1610, 1611 for interfacing with GDS and DCP travel information services, and an air availability engine 1612 for processing the associated information. Similar modules may be provided for processing hotel room, rental car and activity availability information. A hotel room availability module may comprise a display module 1613, modules 1614 for accessing hotel information sources, and a room availability engine 1615 for processing the associated information. Similarly, a rental car availability module may comprise a display module 1616, modules 1617 for accessing hotel information sources, and a car availability engine 1618 for processing the associated information. A similar structure may be used for an activity availability module may comprise an activity availability display module 1619, modules 1620 for accessing local activity information sources, and an activity availability engine 1621 for processing the associated information.

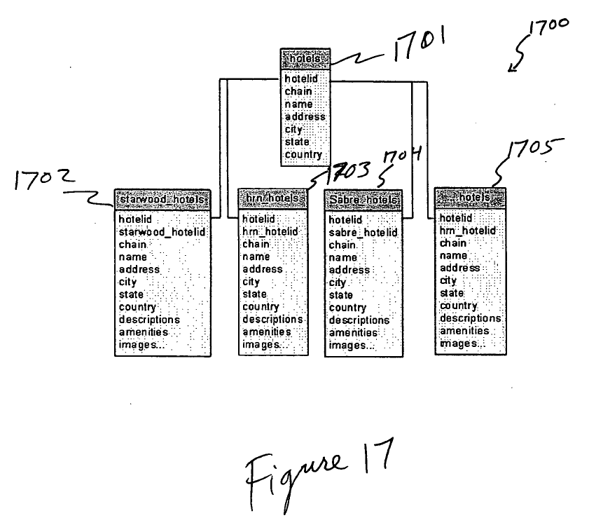

Travel Manager 105 may utilize structured data relationships to organize information by type and service provider. By way of example, but not by way of limitation, FIG. 17 illustrates a data hierarchy 1700 for relating information about hotels within a database. A parent data record 1701 may store information related to all hotels as may be useful in booking and billing functions. Such a parent data record 1701 may include a primary key, such as a hotel ID, a secondary key, such as the name of the hotel chain to which an individual hotel belongs, and the data specific to the hotel, such as name, address, telephone numbers, etc. Individual data records may then be linked by means of primary and/or secondary keys to daughter data records 1702, 1703, 1704, 1705 that provide additional information useful for travel planning purposes. For example, as illustrated in FIG. 17, daughter data records may include information provided by chains or groups of service suppliers or sources of information. For example, daughter data record 1702 provides information related to Starwood Hotels, while daughter data record 1704 store information provided by the Sabre hotel reservation information source. Daughter data records may include a primary key, such as the hotel ID, and one or more secondary keys, such as the key provided by the particular chain, group of services supplier. For example, the Starwood daughter data record 1702 is shown as including a Starwood_hotel_ID that is used by the Starwood chain, while the Sabre daughter data record 1704 is shown as including a Sabre_hotel_ID. Structuring data records in this fashion enables service providers to access and update their data records as discussed above without having to access and revise the parent data records for all such services (e.g., hotels). A person of skill in the art can see that daughter data records may store overlapping information as to individual services or information on the same service (e.g., hotel), since information may be available from, and thus stored according to, multiple information sources, such as the chain that owns the service or facility and GDS or ADS travel information service suppliers (e.g., Sabre).

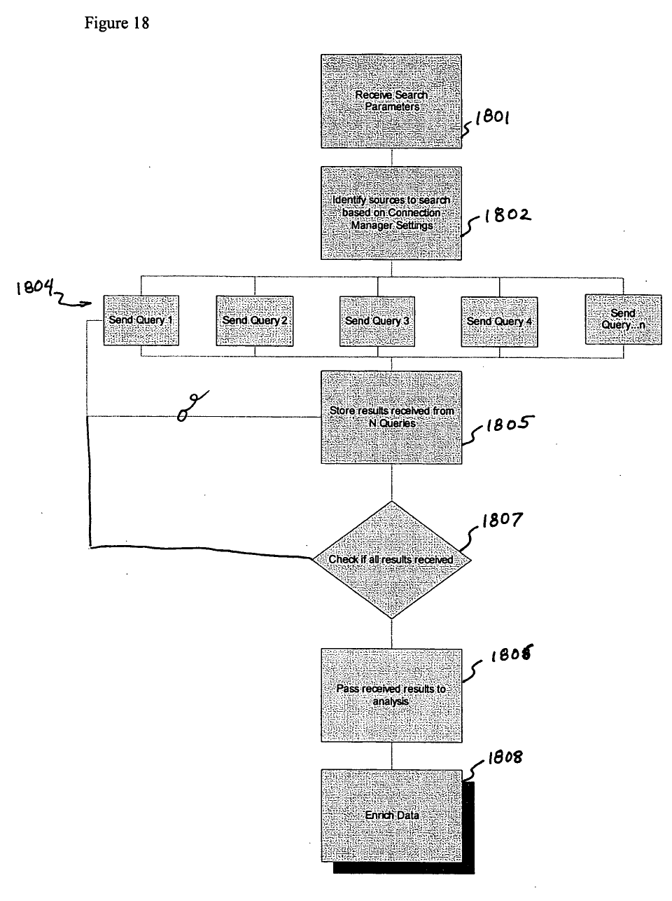

Turning to the method used by the Travel Manager 105 to process information searches and contract filtering in parallel, FIG. 18 provides a flow diagram of steps implemented in such functions. The process may begin when the appropriate search parameters have been received, step 1801, such as from the user, from a client template, from a group (e.g., tour) specification, etc. As discussed above, search parameters will include the types of services required (e.g., air travel, ground transportation, hotel, rental car, local facilities, activities, etc.), as well as pertinent parameters related to those services (e.g., travel dates, special requirements, number of travelers, etc.), as necessary to format queries to appropriate service suppliers.

In step 1802, the search parameters are processed to identify the various information sources and services that should be queried. Such identifications are made for each type of service required. Information stored in local databases may be accessed to identify the appropriate sources of information to be queried, including the electronic address (e.g., URL), the data structure required to query each source, and other information necessary to format a query to each source, such as an account number, password, client identification, etc. In this step, data on the types and formats of data expected to be received from a query to each information source may be obtained from a database to permit preparing a data table of appropriate format to receive incoming information.

The information identified in step 1802 may then be assembled into formatted queries for each of the information sources which may then be held in memory-based data structures, as a document comprising all queries, or in a data table stored in volatile, or on magnetic or other suitable nonvolatile memory medium. Assembling the queries helps to enable parallel queries to the information sources. Alternatively in another step, either before or after step 1802, a data structure may be created to receiver the results from all of the queries to information sources. Such a data structure may also contain multiple fields (e.g., columns) to receive the number and classes of information identified in step 1802 as likely to be received from the information sources.

Having formatted the various queries, the process proceeds in step 1804 to open a number of communication channels, such as TCP/IP connections, to transmit the various queries approximately simultaneously. This may be accomplished by an Internet access server, a server connected to multiple communication lines (e.g., T-1 or conventional telephone, or to a high-speed Internet connections). As one of skill in the art will appreciate, this may be accomplished in a variety of ways. For example, each formatted query may be passed to the Internet access server by the Travel Manager 105 as a separate client or virtual client, resulting in the establishment of some number N virtual clients. The Internet access server uses then opens N TCP/IP sessions, each directed to the IP or URL address contained within the pre-formatted query.

Responses from the N queries will most likely be received by the transmitting computer, such as the Internet access server, at different times as the asynchronous, flexible routing architecture of the Internet will result in varying transmission delays in both ways. Also, the response time of the various information sources will vary. Consequently, the Travel Manager 105 is configured to receive and record query responses until a sufficient number are hand for subsequent processing. This may be accomplished by storing each result in step 1805 in memory-based data structures, appending them to a document held in memory, or posting them each result in step 1805 to a results data table formatted in step 1803. Data may be added to the table sequentially, categorically (e.g., by type of service) or according to source, such as according to an index or key associated with each query in the preformatted query data table.

When a sufficient number of query responses have been received, in step 1806 the data table is then passed to the analysis processor discussed above for analysis and contract filtering. This may be accomplished by transmitting the table to another computer or memory location, or simply by indicating to the analysis module (such as by setting a flag) that the results data table is populated and released for analysis. Contract filtering, ranking, eliminating dominated searches and other analyses may be accomplished in parallel since the search results are stored in a single data table. Such analysis thus can be accomplished by comparing and contrasting among selected fields or across multiple rows as one of ordinary skill in the art can appreciate.

Since Internet communications frequently result in dropped queries for a variety of reasons, the parallel query process may include a step 1807 to determine whether any queries need to be retransmitted. This may be accomplished by searching the results data table for empty rows, by means of a counter set to the number N of queries and decremented as each is received, or by any other means generally known in the software arts. In step 1807, each missing query response is identified, the preformatted query is obtained from the query data table and passed to the communications module, such as the Internet access server, where the query is retransmitted. Results received from retransmitted queries may be posted to a results data table, or passed on to the analysis module directly.

Travel Manager 105, as described in the invention, or any of its components may be embodied in the form of an information-processing engine. The information processing engine performs the role of an Application Service Provider (ASP) that processes the information and provides the end result to the user.

Travel Manager 105 executes a set of instructions that are stored in one or more storage elements in order to process input data. The storage elements, may also hold data or other information as desired. The storage element may be in the form of a database or a physical memory element present in the processing machine.

The set of instructions may include various instructions that instruct the information processing engine to perform specific tasks, such as the steps that constitute the disclosed method. The set of instructions may be in the form of a program or preferences of the end user. The preferences may be received via various forms, such as over a website, or may be provided as system software or application software. Further, the software may be in the form of a collection of separate programs, a program module with a larger program, or a portion of a program module. A person skilled in the art will realize that the software used for implementing the disclosed system, can be coded in any programming language. The software might also include modular programming in the form of object-oriented programming in languages like C++ and Java. The processing of input data by the processing machine may be in response to user commands, in response to results of previous processing, or in response to a request made by another processing machine.

A person skilled in the art can appreciate that it is not necessary that the processing machines and/or storage elements be physically located in the same geographical location. Indeed, these processing machines and/or storage elements may be located in geographically distinct locations and connected to each other through appropriate communication means. Various communication technologies may be used to enable communication between the processing machines and/or storage elements. Such technologies include connection of the processing machines and/or storage elements, in the form of a network. The network can be an intranet, an extranet, the Internet or any client server models that enable communication. Such communication technologies may use various protocols such as TCP/IP, UDP, ATM or OSI.

The foregoing description of various embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable one skilled in the art to utilize the invention in various embodiments and with various modifications as are suited to the particular use contemplated.

1. A reservation system, comprising:
a channel module adapted to receive a reservation request from a user;
an availability module adapted to query a plurality of availability databases and apply packaging rules to filter query results; and
an integration module adapted to integrate filtered query results from the availability module into itinerary options for the user,
wherein the plurality of availability databases comprise an internal database, a distribution system database, and a service provider database.

2. The reservation system of claim 1, wherein the distribution system database comprises at least one of a Global Distribution System (GDS) database and an Alternate Distribution System (ADS) database.

3. The reservation system of claim 1, wherein the service provider database comprises at least one of an airline database, a hotel database, and a rental car database.

4. The reservation system of claim 1, further comprising a contract module adapted to set contracts for reservable services.

5. The reservation system of claim 1, further comprising a content module adapted to display the itinerary options according to a template.

6. The reservation system of claim 5, wherein the template is specific to a geographic location.

7. The reservation system of claim 6, wherein the itinerary options are filtered according to the geographic location of the template.

8. The reservation system of claim 5, wherein the template is specific to a property.

9. The reservation system of claim 8, wherein the itinerary options are filtered according to the property of the template.

10. The reservation system of claim 5, wherein the template is specific to an organization.

11. The reservation system of claim 1,
wherein the user comprises a subagent that resells services, and
wherein the reservation system further comprises a subagent manager module adapted to manage subagents that resell services.

12. The reservation system of claim 1, further comprising an accounting module adapted to receive payment from the user and to pass payment on to service providers.

13. The reservation system of claim 12, wherein the accounting module is further adapted to track and generate reports on service reservations.

14. A method of aggregating service requests involving a plurality of service providers, comprising:
querying the plurality of service providers to identify available inventory based on a service request;
applying inventory rules on the identified available inventory to filter query results;
applying itinerary rules on the filtered query results to create itinerary options;
receiving an itinerary selection selecting one of the itinerary options; and
transmitting a reservation request to each inventory owner corresponding to the itinerary selection.

15. The method of claim 14, wherein the inventory rules comprise rules set by an inventory owner.

16. The method of claim 14, wherein the itinerary rules comprise rules set by a service requestor.

17. The method of claim 14, wherein querying the plurality of service providers comprises querying an internal database, a distribution system database, and a service provider database.

18. The method of claim 17, wherein the service provider database comprises at least one of an airline database, a hotel database, and a rental car database.

19. The method of claim 17, wherein the distribution system database comprises at least one of a Global Distribution System (GDS) database and an Alternate Distribution System (ADS) database.

20. The method of claim 14, further comprising:
displaying the itinerary options on the basis of a template.

21. The method of claim 20, wherein the template comprises one of: a geographic template, a property template, and an organization template.

22. The method of claim 14, further comprising:
receiving payment from a service requester; and
transmitting individual payment to each inventory owner corresponding to the itinerary selection.

23. The method of claim 14,
wherein the method further comprises automatically placing the itinerary options on an auction WebSite, and
wherein receiving an itinerary selection comprises receiving an itinerary selection from a bidder on the auction WebSite.

24. The method of claim 23, further comprising:
receiving payment from the bidder; and
transmitting individual payment to each inventory owner corresponding to the itinerary selection.
